(19) United States
(12) Patent Application Publication
(10) Pub. No.: US 2022/0164303 A1
(43) Pub. Date: May 26, 2022

(54) OPTIMIZATIONS OF BUFFER INVALIDATIONS TO REDUCE MEMORY MANAGEMENT PERFORMANCE OVERHEAD

(71) Applicant: Intel Corporation, Santa Clara, CA (US)

(72) Inventors: Vinay Raghav, Folsom, CA (US); Yesha Shah, Folsom, CA (US); Paras Goyal, Folsom, CA (US); Utkarsh Y. Kakaiya, Folsom, CA (US)

(21) Appl. No.: 17/535,289

(22) Filed: Nov. 24, 2021

Related U.S. Application Data
(60) Provisional application No. 63/118,515, filed on Nov. 25, 2020.

(51) Int. Cl. G06F 13/28; G06F 12/0891

(52) U.S. Cl. CPC G06F 13/28; G06F 2213/28; G06F 2212/1024; G06F 12/0891

(57) ABSTRACT

Methods, apparatus, systems, and articles of manufacture to manage memory in a computing apparatus are disclosed. Methods, apparatus, systems, and articles of manufacture to optimize or improve buffer invalidation to reduce memory management performance overhead are disclosed. An example apparatus includes an input-output memory management unit (IOMMU) circuitry to control access to memory circuitry, the IOMMU circuitry to increment a counter from a first value to a second value when a memory access to a location in the memory circuitry is allocated and to decrement the counter from the second value to the first value when the memory access to the location in the memory circuitry is deallocated; and an operating system (OS) memory manager to enable reallocation of the location in the memory circuitry when the counter is at the first value.

### CROSS-REFERENCE TO RELATED APPLICATIONS

This patent claims priority to and the benefit of U.S. Provisional Patent Application No. 63/118,515, entitled “Optimizations of Buffer Invalidations to Reduce Memory Management Performance Overhead,” filed Nov. 25, 2020, which is incorporated herein by reference in its entirety for all purposes.

### FIELD OF THE DISCLOSURE

This disclosure relates generally to memory management, and, more particularly, to optimizations of buffer invalidations to reduce memory management performance overhead.

### BACKGROUND

Interaction among computing devices can expose one or more of the involved devices to malicious attacks and/or faulty accesses to memory locations that are made available to facilitate the device interaction. Additionally, remedies to protect computing devices from such vulnerabilities introduce performance degradation, which can impact responsiveness and ability of the computing device to effectively and efficiently handle applications and other processes.

### BRIEF DESCRIPTION OF THE DRAWINGS

FIG. 1 depicts an example computing apparatus.

FIG. 2 is a flowchart representative of example machine-readable instructions that can be executed to implement a memory management process.

FIG. 3 is a flowchart representative of example machine-readable instructions that can be executed to implement a memory management process using the example computing apparatus of FIG. 1.

FIGS. 4A-4B are graphs showing relative performance of the example computing apparatus of FIG. 1 without direct memory access remapping, with direct memory access remapping, and with direct memory access remapping leveraging the improved computing apparatus of FIG. 1 and associated process of FIG. 3.

FIG. 5 is a block diagram of an example processor platform structured to execute the instructions of FIGS. 2 and/or 3 to implement the example computing apparatus of FIG. 1.

FIG. 6 is a block diagram of an example implementation of the processor circuitry of FIG. 5.

FIG. 7 is a block diagram of another example implementation of the processor circuitry of FIG. 5.

FIG. 8 is a block diagram of an example software distribution platform to distribute software (e.g., software corresponding to the example computer readable instructions of FIGS. 2 and/or 3) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

### DETAILED DESCRIPTION

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the terms “microservice, “service”, “task”, “operation”, and “function” can be used interchangeably to indicate an application, a process, and/or other software code (also referred to as program code) for execution using computing infrastructure, such as the edge computing environment.

Examples disclosed herein provide optimization and/or other improvement of buffer invalidations to reduce memory management performance overhead. Examples disclosed herein provide an asynchronous memory buffer invalidation request to enable other memory access to continue while the memory buffer invalidation is handled.

Rather than managing memory as individual bytes, many computer architectures manage memory in physically and virtually contiguous blocks, referred to as pages. These blocks of memory can be stored in random access memory (RAM), for example. When program code is executed, page addresses to access memory locations are translated from virtual addresses used by software applications to physical addresses used by computer hardware. This translation is using page tables, which map virtual addresses to physical addresses on a page-by-page basis. To improve performance, a set of most recently used (or most frequently used) page addresses for accessed memory locations can be stored in a cache referred to as a translation lookaside buffer (TLB).

A memory management unit (MMU), also referred to herein as a memory manager or a memory management circuit, is physical hardware that controls virtual memory and caching operations. The MMU can be located in a computer's central processing unit (CPU), a separate integrated circuit (IC), etc. Data requests are processed by the MMU, which determines a location from which the data is to be retrieved. The MMU can facilitate hardware memory management, operating system memory management, application memory management, etc.

For example, the MMU translates a virtual address that is visible to a computer processor into a physical address in memory. Hardware memory management manages system and cache memory. An operating system (OS) MMU manages resources among objects and data structures. Application memory management allocates and optimizes memory among applications. A translation lookaside buffer (TLB) is a table that matches virtual addresses to physical addressed.

An input-output memory management unit (IOMMU) is an MMU that connects a direct memory access (DMA) capable input/output (I/O) bus to main memory. The IOMMU maps device-visible virtual addresses to physical addresses. Using DMA, a device (e.g., certain computer hardware, etc.), a virtual machine, etc., can access main system memory (e.g., RAM, etc.) directly without engaging with the CPU or other system processor. Such DMA can expose a computer system to attacks because the CPU may not be able regulate such access. In certain examples, the IOMMU can help protect memory from attack or intrusion from faulty and/or malicious devices. For example, memory is protected from direct memory attacks or errant file transfers because the IOMMU does not allow a device to read or write to memory that has not been allocated for it. As such, the IOMMU only allows access to certain memory areas but blocks or otherwise obscures access to other memory space.

IOMMUs can be used in server and client platforms for protection against DMA attacks by malicious peripheral component interconnect (PCI) devices connected to a host system. For example, operating systems leverage DMA remapping feature of the IOMMUs for system security. DMA remapping allows creation of “per device” domains, in which each DMA transaction requires translation (e.g., from an input/output virtual address (IOVA) to a host physical address, etc.) using IOMMU page tables that are setup by system software. An IOVA is an arbitrary address assigned by the IOMMU in place of a physical address. A requesting device is unaware that the IOMMU maps an IOVA to a physical address. IOMMUs can implement input/output translation lookaside buffers (IOTLBs) to facilitate faster memory address lookup. Rather than a physical address for hardware, the IOMMU, alone or in conjunction with the operating system, can assign an IOVA to the hardware, and the IOVA can be translated to the physical address using the IOTLB, for example.

After such a direct memory access, the IOTLB is to be invalidated (e.g., so that the memory location can no longer be accessed by that device and is available for reallocation). However, the IOTLB invalidation is a blocking call, which blocks further memory operations at the IOMMU until the invalidation is completed and the memory is made available. Since the instruction execution is a blocking call, other DMA are blocked from executing until the buffer invalidation is complete. As such, the IOTLB invalidation (also referred to herein as a buffer invalidation or DMA remapping) generates increased performance overhead and results in lower available bandwidth. Some I/O stacks, such as for data storage operations, experience a more than 40% decrease in performance with respect to some industry benchmarks when allowing DMA and IOTLB invalidation cleanup.

Some operating systems (such as Linux) have “batched” or “lazy” IOTLB invalidations, in which IOTLB invalidations are batched. As such, a plurality of buffer invalidations are queued or batched until a threshold is reached (e.g., every 100 cycles, every 100 cycles, etc.). Then all of the batched IOTLB invalidations are performed together. This allows the upper layer stacks to not be “blocked” to issue subsequent DMAs until invalidations are completed. However, while the invalidation requests are being batched and an associated application has freed the virtual memory (e.g., after DMA completion), the operating system memory manager can reassign the corresponding physical memory to another process before the invalidation is completed. Such reassignment of a memory space previously allocated to another process is a security risk because a stale IOTLB entry can be used by a malicious device to gain unauthorized access to host physical memory before the IOTLB is flushed in the batch.

Additionally, when IOTLB invalidations are batched (e.g., with a queue size of 64 megabytes (MB), 128 MB, etc.), stale IOTLBs are unused until the batched invalidation is completed. The presence of stale IOTLBs between batch invalidations effectively reduces IOTLB usage and causes performance loss across device stacks, for example.

Certain examples address these deficiencies by providing systems and methods to optimize and/or otherwise improve IOTLB invalidation process(es) to help reduce performance overhead of DMA remapping. Certain examples make a buffer (e.g., IOTLB) invalidation a non-blocking call, rather than a blocking call. As such, as soon as an invalidation is requested, control returns for DMA access before invalidation of the IOTLB is performed. However, a safeguard ensures that the memory location affected by the IOTLB invalidation cannot be reallocated until the invalidation is complete. For example, a counter can be incremented when an IOTLB invalidation instruction is sent to the IOMMU. When the invalidation is finished, the counter is decremented. When the operating system and/or the IOMMU sees that the counter has been decremented, the memory location can be reallocated to another application, process, device, etc.

For example, a one gigabyte (GB) application to be executed includes hundreds of thousands of memory map calls to be executed in a sequence. Each call is waiting for cleanup of the previous call. By reducing or eliminating the waiting for cleanup, code execution and associated memory processing can be improved.

Metadata associated with memory operations can include a reference count. In certain examples, the operating system will not reallocate a memory location if its associated reference count is one or more. The operating system reallocates when the reference count value is zero. Setting the reference count to a non-zero value (e.g., incrementing metadata of a page-frame number (PFN) to 1, etc.) prevents the IOMMU and/or other memory manager, such as the OS memory manager, etc., from reallocating the memory address to another process. As such, an asynchronous IOTLB invalidation call increments the reference count, and acknowledgement of invalidation completion decrements the count to allow for reallocation of the memory address. The IOMMU checks the reference count before reallocating the PFN to another process, for example.

Thus, certain examples create a new “pending free” state for a PFN that has an associated outstanding input/output (I/O) virtual address (IOVA). The pending free state is combined with a new asynchronous IOTLB invalidation scheme to help ensure that the OS memory manager does not reallocate memory that is currently “pending free.” While invalidation is being completed asynchronously, subsequent memory map calls do not have to wait for previous invalidations to be completed. However, the IOVA for a particular allocated location is not freed and made available for reallocation until IOTLB invalidation completes, as indicated by the PFN and/or other reference counter.

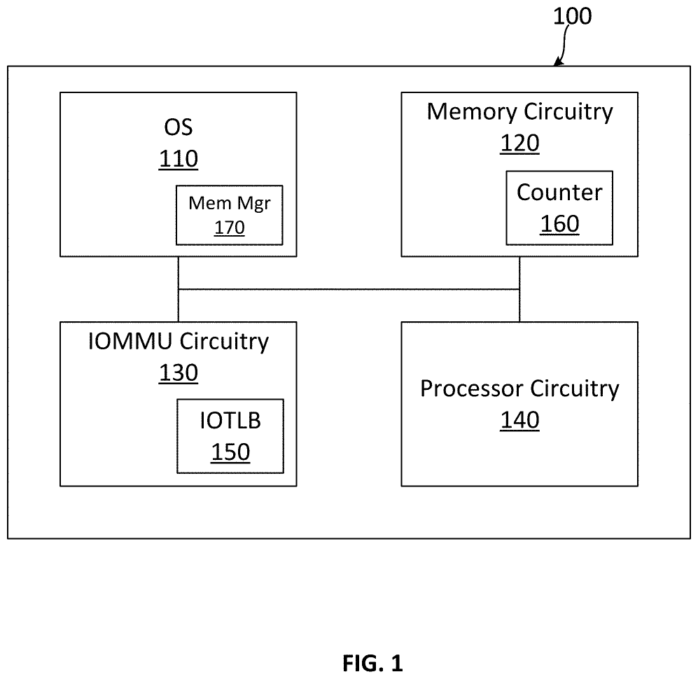

FIG. 1 is an example computing apparatus 100 including an operating system (OS) 110, a memory circuitry 120, an IOMMU circuitry 130, and a processor circuitry 140. As shown in the example of FIG. 1, the example IOMMU circuitry 130 includes an IOTLB 150, the example memory circuitry 120 includes a counter 160 (e.g., implemented as metadata associated with a page table of PFN entries in the memory 120, etc.), and the example OS 110 includes an OS memory manager 170. While the counter 160 is shown in the memory 120, the counter 160 can also be stored in the OS 110 and/or the IOMMU circuitry 130, for example. Similarly, the OS memory manager 170 is shown in the OS 110 but can also be implemented as part of the example memory circuitry 120, for example. The example IOMMU circuitry 130 allocates memory address space (e.g., in a dedicated domain for direct memory access, etc.) to various devices, tasks, etc., such as the processor circuitry 140. When an application is downloaded to the memory allocated by the IOMMU circuitry 130, for example, the processor circuitry 140 can execute that application.

In operation, the IOMMU circuitry 130 assigns an IOVA in the memory circuitry 120 to a process, device, etc. (e.g., the processor circuitry 140, an external computing device, etc.), as part of a DMA map call to access the memory circuitry 120. When the IOVA is assigned, the IOMMU circuitry 130 creates a reference count in metadata of a PFN and/or other reference counter 160 associated with the memory address. When the DMA is complete, the OS 110 (e.g., using the OS memory manager 170) works with the IOMMU circuitry 130 to invalidate or release allocated memory circuitry 120 and associated IOTLB 150 entry(-ies). The invalidation is triggered with an asynchronous call or instruction to allow other memory map calls to proceed while the domain allocation is being invalidated and released for reallocation.

The example counter 160 is leveraged as an indicator of whether or not a memory location can be allocated. For example, the counter 160 is incremented by the IOMMU circuitry 130 when a memory location and associated IOTLB 150 entry are ready to be invalidated (e.g., released to remove the access right and make available for reallocation). Once the invalidation is complete, the counter 160 is decremented by the IOMMU circuitry 130. For example, once the IOTLB invalidation is complete, the IOVA is freed in the memory 120. The OS memory manager 170 and/or the IOMMU circuitry 130 is then able to reallocate that location (e.g., address, address range, etc.) in the memory circuitry 120. For example, the IOMMU circuitry 130 checks the PFN's reference count before freeing and reallocating the IOTLB to another process.

Thus, certain examples enable asynchronous memory and buffer allocation and invalidation to support DMA and other memory access without affecting application or other driver flows. Adjustments can be made by the IOMMU circuitry 130 (alone or with the OS memory manager 170) to adapt and deploy dynamically, for example.

The example OS 110, the example memory circuitry 120, the example IOMMU circuitry 130, the example processor circuitry 140, the example IOTLB 150, the example counter 160, the example OS memory manager 170, and/or, more generally, the example apparatus 100 of the illustrated example of FIG. 1 is/are implemented by a logic circuit such as a hardware processor. However, any other type of circuitry can additionally or alternatively be used such as one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), Coarse Grained Reduced precision architecture (CGRA(s)), image signal processor(s) (ISP(s)), etc. In some examples, the example OS 110, the example memory circuitry 120, the example IOMMU circuitry 130, the example processor circuitry 140, the example IOTLB 150, the example counter 160, the example OS memory manager 170, and/or, more generally, the example apparatus 100 are implemented by separate logic circuits.

While FIG. 1 illustrates an example implementation of the computing apparatus 100, one or more of the elements, processes and/or devices illustrated in FIG. 1 can be combined, divided, re-arranged, omitted, eliminated and/or implemented in any other way. Further, the example OS 110, the example memory circuitry 120, the example IOMMU circuitry 130, the example processor circuitry 140, the example IOTLB 150, the example counter 160, the example OS memory manager 170, and/or, more generally, the example apparatus 100 can be implemented by hardware, software, firmware and/or any combination of hardware, software and/or firmware. Thus, for example, any of the example OS 110, the example memory circuitry 120, the example IOMMU circuitry 130, the example processor circuitry 140, the example IOTLB 150, the example counter 160, the example OS memory manager 170, and/or, more generally, the example apparatus 100 can be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example OS 110, the example memory circuitry 120, the example IOMMU circuitry 130, the example processor circuitry 140, the example IOTLB 150, the example counter 160, the example OS memory manager 170, and/or, more generally, the example apparatus 100 is/are hereby expressly defined to include a non-transitory computer readable storage device or storage disk such as a memory, a digital versatile disk (DVD), a compact disk (CD), a Blu-ray disk, etc. including the software and/or firmware. Further still, the example computing apparatus 100 of FIG. 1 can include one or more elements, processes and/or devices in addition to, or instead of, those illustrated in FIG. 1, and/or can include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

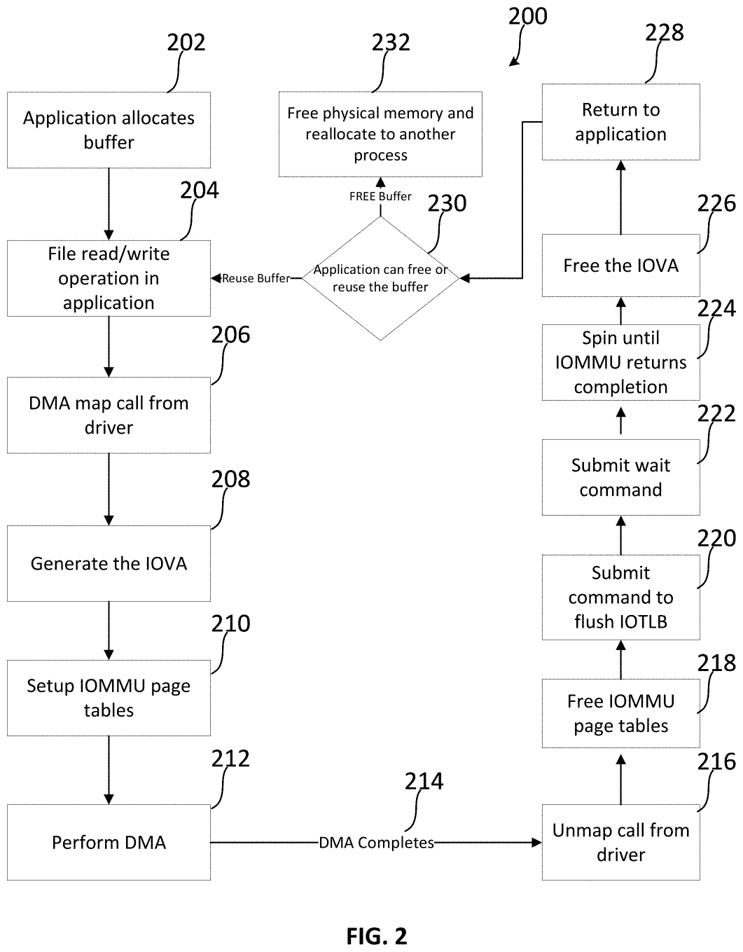

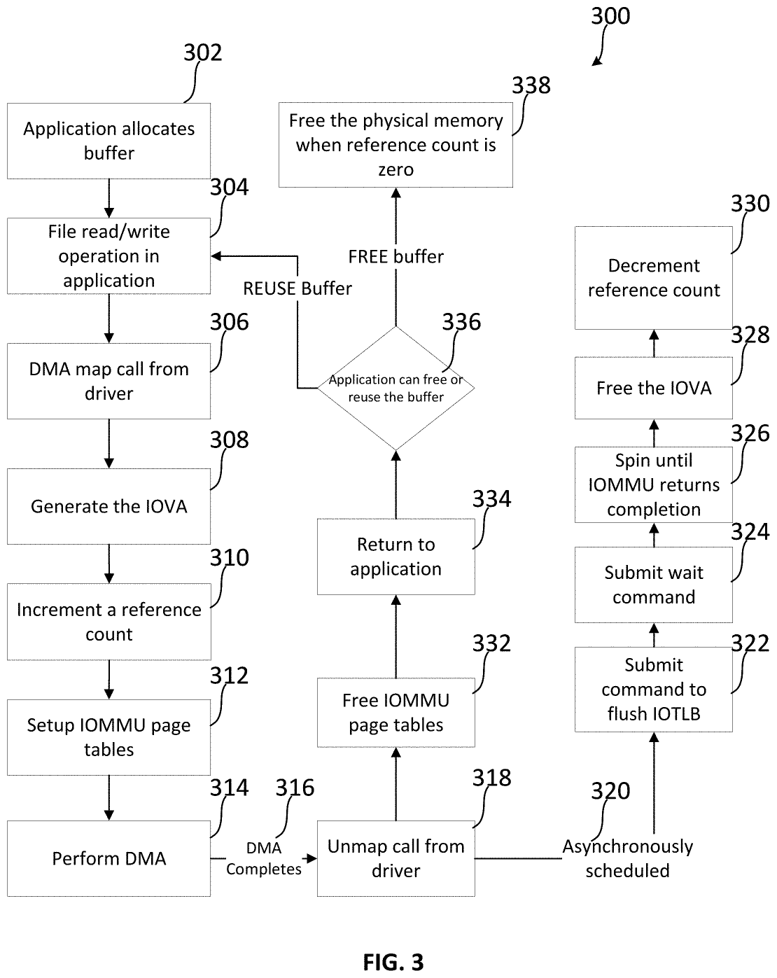

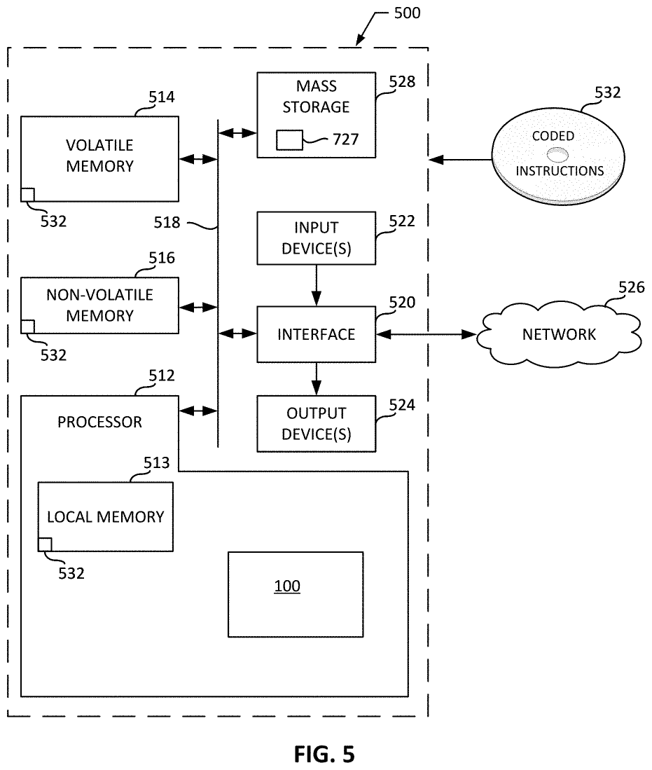

Flowcharts representative of example hardware logic, machine readable instructions, hardware implemented state machines, and/or any combination thereof for implementing the example computing apparatus 100 of FIG. 1 are shown in FIGS. 2-3. The machine readable instructions can be one or more executable programs or portion(s) of an executable program for execution by a computer processor and/or processor circuitry, such as the processor 512 shown in the example processor platform circuitry 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowcharts illustrated in FIGS. 2-3, many other methods of implementing the example computing apparatus 100 can alternatively be used. For example, the order of execution of the blocks can be changed, and/or some of the blocks described can be changed, eliminated, or combined. Additionally or alternatively, any or all of the blocks can be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry can be distributed in different network locations and/or local to one or more devices (e.g., a multi-core processor in a single machine, multiple processors distributed across a server rack, etc.).

The machine readable instructions described herein can be stored in one or more of a compressed format, an encrypted format, a fragmented format, a compiled format, an executable format, a packaged format, etc. Machine readable instructions as described herein can be stored as data or a data structure (e.g., portions of instructions, code, representations of code, etc.) that may be utilized to create, manufacture, and/or produce machine executable instructions. For example, the machine readable instructions can be fragmented and stored on one or more storage devices and/or computing devices (e.g., servers) located at the same or different locations of a network or collection of networks (e.g., in the cloud, in edge devices, etc.). The machine readable instructions may involve one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions can be stored in multiple parts, which are individually compressed, encrypted, and stored on separate computing devices, wherein the parts when decrypted, decompressed, and combined form a set of executable instructions that implement one or more functions that can together form a program such as that described herein.

In another example, the machine readable instructions can be stored in a state in which they can be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 2 and/or 3 can be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more,” and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 2 is a flowchart representative of example machine-readable instructions that can be executed to implement the example computing apparatus 100 of FIG. 1. However, the example process 200 represents a prior process flow that does not take advantage of the new, improved elements of the example computing apparatus 100. The example process 200 of the illustrated example of FIG. 2 begins when an application allocates a buffer (e.g., the IOTLB 150, etc.). (Block 202). Read/write operation(s) to the memory 120 then occur with respect to the application. (Block 204). A driver executes a DMA map call for direct access to a location in the memory 120. (Block 206). An IOVA is generated based on the DMA map call to enable access to the memory 120. (Block 208). IOMMU page table(s) are generated to track memory locations. (Block 210). The DMA is then performed. (Block 212).

Once the DMA is completed (214), the driver sends an unmap call to the IOMMU 130. (Block 216). IOMMU 130 page tables are freed. (Block 218). A command to flush the IOTLB 150 is generated to release the memory access. (Block 220). A wait command is sent to stop or block further memory processing while the IOTLB 150 is flushed to invalidate the memory access. (Block 222). The process 200 waits or spins idle until the IOMMU 130 returns an indication of invalidation completion. (Block 224). Then the IOVA is freed for reallocation. (Block 226). Control flow then returns to the application. (Block 228).

The application can free or reuse the buffer (e.g., the IOTLB 150, etc.). (Block 230). When the buffer is reused, control returns to Block 204 for another read/write operation. When the buffer is freed, the OS memory manager 170 frees physical memory 120 and can reallocate that memory 120 to another process. (Block 232).

Such a prior read/write process flow 200 as shown in the example of FIG. 2 represents an inefficient and ineffective synchronous approach to memory access operations. Using the synchronous DMA mapping and un-mapping of FIG. 2 forces a driver to wait until the IOTLB 150 is flushed to complete invalidation of the memory access to enable reuse of the buffer and associated memory 120. Such invalidation is inefficient and time-consuming. For example, a one gigabyte (GB) file transfer can result in more than one million map and un-map calls to a buffer that must then be invalidated.

Asynchronous invalidation can improve the memory allocation and access process to be more effective and more efficient. In contrast to the example process 200 of FIG. 2, using asynchronous invalidation helps ensure that subsequent map calls do not have to wait for previous invalidations to complete. The IOVA is freed after invalidation of the IOTLB 150 is complete.

As such, certain examples address performance issues as well as security concerns with reallocation of physical memory from one process to another by the OS memory manager 170. When an IOVA is assigned as part of a DMA map call, a reference count is in metadata of an associated PFN. After DMA is complete, IOTLB invalidations are asynchronously completed such that upper layer stacks are not “blocked” to issue subsequent DMAs until the invalidations are completed. The reference count associated with the PFN is decremented when the corresponding IOVA is freed (e.g., as part of the asynchronous IOTLB invalidations). The OS memory manager 170 checks the PFN's reference count before freeing (and reallocating) the buffer to another process. As such, the improved process does not affect application or driver flows. The changes are contained within the OS managed IOMMU 130 and code of the OS memory manager 170, which enables easier adaptation and deployment.

FIG. 3 is a flowchart representative of example machine-readable instructions that can be executed to implement the example computing apparatus 100 of FIG. 1. The example process 300 of the illustrated example of FIG. 3 begins when an application allocates a buffer (e.g., the IOTLB 150, etc.). (Block 302). For example, a buffer can be allocated for a transfer of a file from a source location to the memory circuitry 120 and/or other execution in association with the application.

Read/write operation(s) to the memory circuitry 120 then occur with respect to the application. (Block 304). For example, execution of read/write operations is triggered or otherwise initiated to transfer the file from the source location to the memory circuitry 120 via the buffer.

As part of the read/write operations, a driver executes a DMA map call for direct access to a location in the memory circuitry 120. (Block 306). For example, the driver (e.g., associated with the OS 110 and activated by the OS 110 and/or by the source location, etc.) executes a DMA map call to directly access a specified location in the memory circuitry 120 to write a portion of the file to be transferred. However, the memory circuitry 120 location is masked for security reasons, etc. As such, an IOVA is generated by the IOMMU circuitry 130 based on the DMA map call to enable access to the memory circuitry 120. (Block 308). For example, the IOVA can be provided to the driver (e.g., acting on behalf of the source location, etc.) as an intermediary or mask for the requested direct memory access (DMA) such that an outside actor (e.g., a program at the source location, etc.) is unable to access the location in the memory circuitry 120 directly. The IOVA maps to the DMA address to enable the masked or indirect memory access via the DMA call.

In conjunction with the generation of the IOVA, a reference count is incremented in the counter 160 to reflect the generation of the IOVA for the application. (Block 310). For example, the counter 160 originally has a value of 0 and is incremented to 1 based on the generation of the IOVA for the DMA call. IOMMU page table(s) are generated to track memory locations. (Block 312). The reference counter 160 can be implemented as a PFN or metadata associated with the PFN in the IOMMU page table stored in memory circuitry 120, for example. The DMA is then performed. (Block 314).

Once the DMA is completed (316), the driver sends an unmap call to the IOMMU circuitry 130. (Block 318). The unmap call is asynchronously scheduled (320) so that other memory circuitry 120 operations can continue. A command to flush the IOTLB 150 is generated to release the memory access. (Block 322). A wait command is sent to stop or block further memory processing while the IOTLB 150 is flushed to invalidate the memory access. (Block 324). The process 300 waits or spins idle until the IOMMU circuitry 130 returns an indication of invalidation completion. (Block 326). Then the IOVA is freed for reallocation. (Block 328). The reference count is then decremented (e.g., from 1 to 0, from an incremented value back to an original value, etc.). (Block 330).

In parallel, IOMMU 130 page tables are freed. (Block 332). Control flow then returns to the application. (Block 334). The application can free or reuse the buffer (e.g., the IOTLB 150, etc.). (Block 336). When the buffer is reused, control returns to Block 304 for another read/write operation. When the buffer is freed, the OS memory manager 170 frees physical memory 120 and can reallocate that memory 120 to another process. (Block 338). However, the memory circuitry 120 is only freed for reallocation with the reference counter 160 is zero (or otherwise decremented to its starting value).

As such, IOMMU page tables can be freed and control can return to the application while the IOTLB 150 and/or other buffer is being flushed and invalidated for next use. The application can reuse the buffer while the example process is occurring but cannot free the IOTLB 150 buffer until the reference count of the example counter 160 has returned to its original or prior value (e.g., returned to 0 after being incremented to 1 for the allocation process, etc.).

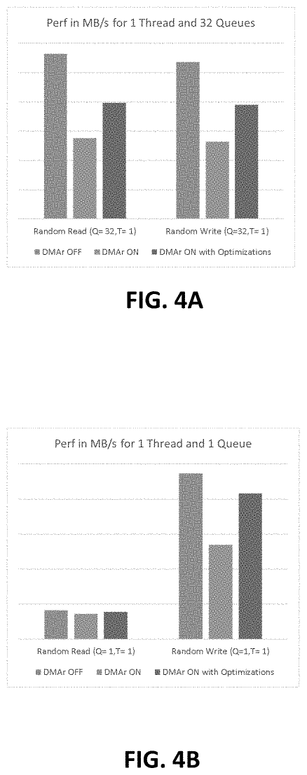

FIGS. 4A-4B illustrate example graphs showing a difference in computing performance when DMA remapping is allowed (e.g., turned on) rather than not allowed (e.g., turned off). As shown the example of FIG. 4A, a performance drop with DMA remapping (also referred to as kernel DMA protection) is significant for some I/O workloads. For example, FIG. 4A shows a 10%-50% performance drop with some random read/write traffic. As shown in the example of FIG. 4A, performance in megabytes/second (MB/s) for 1 thread and 32 queues on both a random read and a random write shows a significant performance decrease when DMA remapping (DMAr) is turned on. However, using the improvements described herein, such as parallel processing enabled by the reference counter 160, reduces the degree of performance degradation caused by DMA remapping (e.g., due to the delays introduced by invalidating the created buffer, etc.). Similar effects are shown in the example of FIG. 4B, which illustrates an effect on a random read and a random write using 1 thread and 1 queue.

Thus, interaction between the IOMMU circuitry 130, the memory manager 170, and the counter 160 drives improved processing speed and efficiency by enabling memory allocation and deallocation to proceed largely in parallel using the counter 160 to drive action by the memory manager 170 to deallocate and reallocate in conjunction with the IOMMU circuitry 130.

FIG. 5 is a block diagram of an example processor platform 500 structured to execute the instructions of FIGS. 2 and/or 3 to implement the example computing apparatus or infrastructure 100 of FIG. 1. The processor platform 500 can be, for example, a server, a personal computer, a workstation, a self-learning machine (e.g., a neural network), a mobile device (e.g., a cell phone, a smart phone, a tablet such as an iPad™, an Internet appliance, a gaming console, a headset or other wearable device, or other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 512 implements the example computer apparatus or architecture 100.

For example, the example processor 512 can be used to implement the example processor circuitry 140 of the example apparatus 100, for example. The example processor 512 can also be used to implement the example IOMMU circuitry 130, for example. The example OS 110 can run on the example processor 512, for example. All or part of the example memory circuitry 120 can be implemented by the processor 512, alone or in conjunction with local memory 513 and/or other memory of the example processor platform 500, for example.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 can be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 can be implemented by flash memory and/or any other desired type of memory device. Access to the main memory 514, 516 is controlled by a memory controller.

The processor platform 500 of the illustrated example also includes an interface circuit 520. The interface circuit 520 can be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip, and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIGS. 2 and/or 3 can be stored in the local memory 513, the mass storage device 528, in the volatile memory 514, in the non-volatile memory 516, and/or on a removable non-transitory computer readable storage medium such as a CD or DVD. The example memory circuitry 120 can be stored in the local memory 513, the mass storage device 528, in the volatile memory 514, in the non-volatile memory 516, etc.

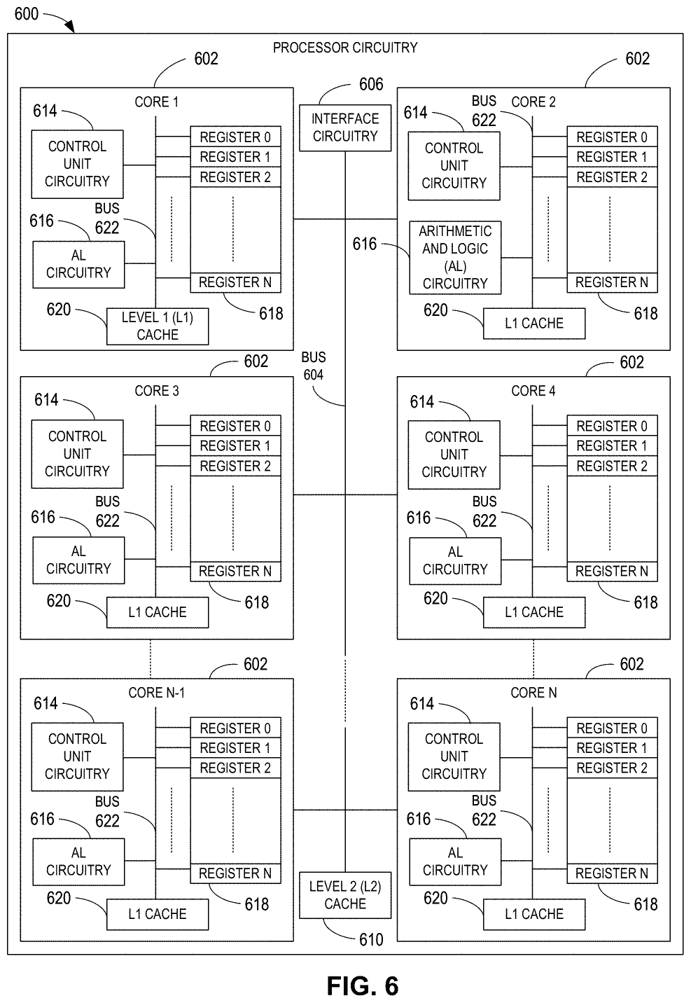

FIG. 6 is a block diagram of an example implementation of the processor circuitry 512 of FIG. 5. In this example, the processor circuitry 512 of FIG. 5 is implemented by a microprocessor 600. For example, the microprocessor 600 may implement multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowchart of FIG. 3.

The cores 602 may communicate by an example bus 604. In some examples, the bus 604 may implement a communication bus to effectuate communication associated with one(s) of the cores 602. For example, the bus 604 may implement at least one of an Inter-Integrated Circuit (I2C) bus, a Serial Peripheral Interface (SPI) bus, a PCI bus, or a PCIe bus. Additionally or alternatively, the bus 604 may implement any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the L1 cache 620, and an example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The bus 604 may implement at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

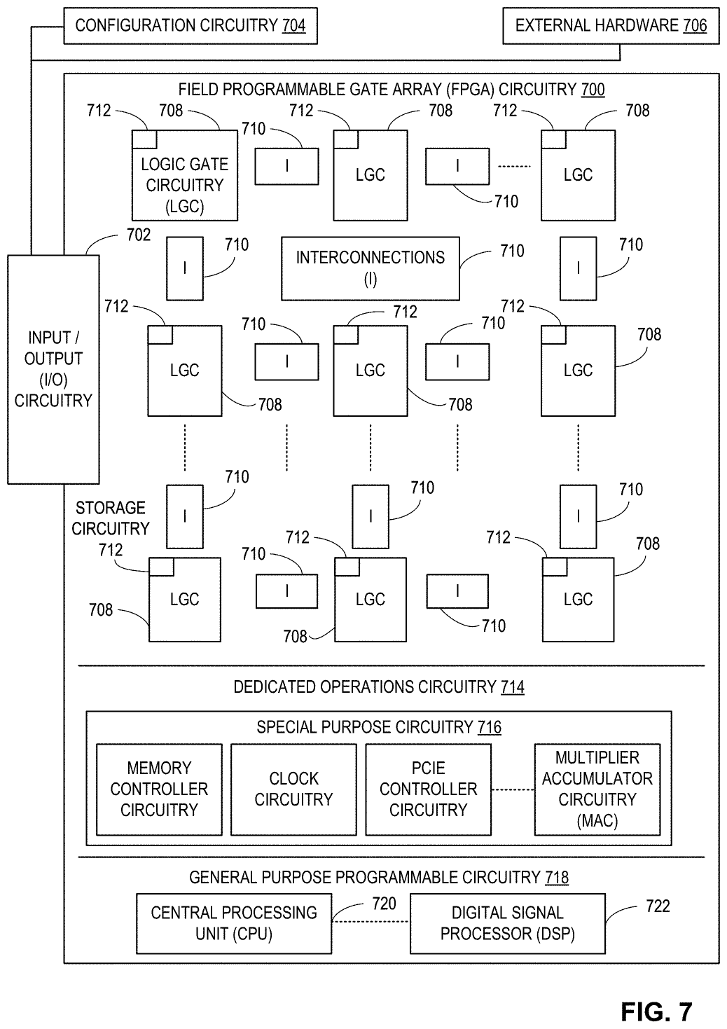

FIG. 7 is a block diagram of another example implementation of the processor circuitry 512 of FIG. 5. In this example, the processor circuitry 512 is implemented by FPGA circuitry 700. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the machine readable instructions represented by the flowchart of FIG. 3 but whose interconnections and logic circuitry are fixed once fabricated), the FPGA circuitry 700 of the example of FIG. 7 includes interconnections and logic circuitry that may be configured and/or interconnected in different ways after fabrication to instantiate, for example, some or all of the machine readable instructions represented by the flowchart of FIG. 3. In particular, the FPGA 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the flowchart of FIG. 3. As such, the FPGA circuitry 700 may be structured to effectively instantiate some or all of the machine readable instructions of the flowchart of FIG. 3 as dedicated logic circuits to perform the operations corresponding to those software instructions in a dedicated manner analogous to an ASIC. Therefore, the FPGA circuitry 700 may perform the operations corresponding to the some or all of the machine readable instructions of FIG. 3 faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware (e.g., external hardware circuitry) 706. For example, the configuration circuitry 704 may implement interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may implement the microprocessor 600 of FIG. 6. The FPGA circuitry 700 also includes an array of example logic gate circuitry 708, a plurality of example configurable interconnections 710, and example storage circuitry 712. The logic gate circuitry 708 and interconnections 710 are configurable to instantiate one or more operations that may correspond to at least some of the machine readable instructions of FIG. 3 and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions represented by the flowchart of FIG. 3 may be executed by one or more of the cores 602 of FIG. 6 and a second portion of the machine readable instructions represented by the flowchart of FIG. 3 may be executed by the FPGA circuitry 700 of FIG. 7.

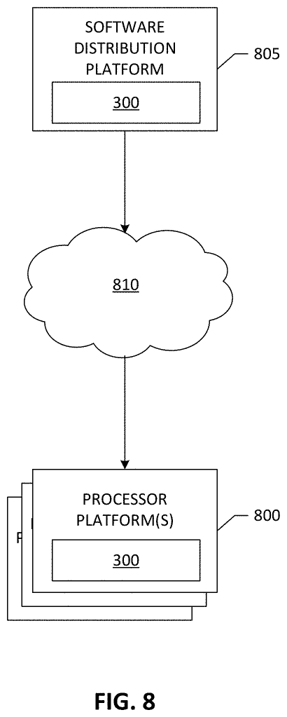

A block diagram illustrating an example software distribution platform 805 to distribute software such as the example computer readable instructions 200 of FIG. 2 and/or the computer readable instructions 300 of FIG. 3 to third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 200, 300 of FIGS. 2 and/or 3. The third parties may be consumers, users, retailers, OEMs, etc., who purchase and/or license the software for use and/or re-sale and/or sub-licensing. In the illustrated example, the software distribution platform 805 includes one or more servers and one or more storage devices, such as storage devices 513, 514, 516, 512 described above. The storage devices store respective computer readable instructions 200, 300, as described above. The one or more servers of the example software distribution platform 805 are in communication with a network 810, which may correspond to any one or more of the Internet and/or any of the example networks 526 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 200, 300 from the software distribution platform 805. For example, the example computer readable instructions 300 of FIG. 3, may be downloaded to the example processor platform 500, which is to execute the computer readable instructions 300 to implement the example computing apparatus 100 (or configure the example computing apparatus 100 accordingly). In some examples, one or more servers of the software distribution platform 805 periodically offer, transmit, and/or force updates to the software (e.g., the example computer readable instructions 300 of FIG. 3, etc.) to ensure improvements, patches, updates, etc. are distributed and applied to the software at the end user devices.

From the foregoing, it will be appreciated that example methods, apparatus, systems, and articles of manufacture have been disclosed that enable dynamic management of direct memory access and allocation/deallocation of memory space and associated buffer. Certain examples establish a counter system to provide for parallel memory allocation and invalidation/deallocation to reduce performance degradation caused by direct memory access reallocation. Absent DMA reallocation, a computing apparatus is vulnerable to infiltration and attack. As such, improvements to allocation and deallocation of memory and associated buffer represent a technological improvement in computer security, memory management, and computer architecture. Disclosed methods, apparatus and articles of manufacture are accordingly directed to one or more improvement(s) in the functioning of a computer.

Further examples and combinations thereof include the following:

Example 1 is an apparatus including: processor circuitry to: when an input/output virtual address (IOVA) is assigned for a direct memory access (DMA), allocate a buffer and create a reference associated with a page-frame number (PFN); after the DMA, invalidate the buffer and free the IOVA; update the reference after the IOVA is freed; and reallocate the buffer based on a status of the reference.

Example 2 includes the apparatus of example 1, wherein the processor circuitry is to create the reference in metadata associated with the PFN.

Example 3 includes the apparatus of example 1, wherein the processor circuitry is to invalidate the buffer asynchronously.

Example 4 includes the apparatus of example 3, wherein the DMA is a first DMA, and wherein the processor circuitry is to issue a second DMA before the buffer is invalidated.

Example 5 includes the apparatus of example 1, wherein the processor circuitry is to invalidate the buffer by flushing the buffer after the DMA is complete.

Example 6 includes the apparatus of example 1, wherein the processor circuitry is to map a physical address in memory circuitry to the IOVA to provide access to a location in the memory circuitry, the processor circuitry to translate from the IOVA to the physical address to at least one of read or write to the location in the memory circuitry.

Example 7 includes the apparatus of example 1, wherein the processor circuitry is to free one or more page tables when the buffer is invalidated.

Example 8 includes the apparatus of example 1, wherein the processor circuitry is to check the reference before reallocating the buffer.

Example 9 includes the apparatus of example 8, further including a memory manager to check the reference before reallocating the buffer.

Example 10 is at least one non-transitory computer readable storage medium including instructions that, when executed, cause circuitry to at least: when an input/output virtual address (IOVA) is assigned for a direct memory access (DMA), allocate a buffer and create a reference associated with a page-frame number (PFN); after the DMA, invalidate the buffer and free the IOVA; update the reference after the IOVA is freed; and reallocate the buffer based on a status of the reference.

Example 11 includes the at least one non-transitory computer readable storage medium of example 10, wherein the instructions, when executed, cause the circuitry to create the reference in metadata associated with the PFN.

Example 12 includes the at least one non-transitory computer readable storage medium of example 10, wherein the instructions, when executed, cause the circuitry to invalidate the buffer asynchronously.

Example 13 includes the at least one non-transitory computer readable storage medium of example 12, wherein the DMA is a first DMA, and wherein the instructions, when executed, cause the circuitry to issue a second DMA before the buffer is invalidated.

Example 14 includes the at least one non-transitory computer readable storage medium of example 10, wherein the instructions, when executed, cause the circuitry to invalidate the buffer by flushing the buffer after the DMA is complete.

Example 15 includes the at least one non-transitory computer readable storage medium of example 10, wherein the instructions, when executed, cause the circuitry to map a physical address in a memory to the IOVA to provide access to a location in the memory, the circuitry to translate from the IOVA to the physical address to at least one of read or write to the location in the memory.

Example 16 is a computer-implemented method including: when an input/output virtual address (IOVA) is assigned for a direct memory access (DMA), allocating a buffer and creating a reference associated with a page-frame number (PFN); after the DMA, invalidating the buffer and freeing the IOVA; updating the reference after the IOVA is freed; and reallocating the buffer based on a status of the reference.

Example 17 includes the method of example 16, wherein creating the reference includes creating the reference in metadata associated with the PFN.

Example 18 includes the method of example 16, wherein invaliding the buffer includes invalidating the buffer asynchronously.

Example 19 includes the method of example 18, wherein the DMA is a first DMA, and wherein the method includes issuing a second DMA before the buffer is invalidated.

Example 20 includes the method of example 16, wherein invalidating the buffer includes invalidating the buffer by flushing the buffer after the DMA is complete.

Example 21 is an apparatus including: an input-output memory management unit (IOMMU) circuitry to control access to memory circuitry, the IOMMU circuitry to increment a counter from a first value to a second value when a memory access to a location in the memory circuitry is allocated and to decrement the counter from the second value to the first value when the memory access to the location in the memory circuitry is deallocated; and an operating system (OS) memory manager to enable reallocation of the location in the memory circuitry when the counter is at the first value.

Example 22 includes the apparatus of example 21, wherein the IOMMU circuitry includes a buffer.

Example 23 includes the apparatus of example 22, wherein the buffer includes at least one input/output translation lookaside buffer.

Example 24 includes the apparatus of example 22, wherein the IOMMU circuitry is to flush the buffer when the memory access to the location in the memory circuitry is deallocated.

Examples 25 includes the apparatus of example 21, wherein the OS memory manager is included in an operating system.

Example 26 includes the apparatus of example 21, wherein the IOMMU circuitry includes a processor.

Example 27 includes the apparatus of example 21, wherein the IOMMU circuitry is to map a physical address in the memory circuitry to an input/output virtual address to provide access to the location in the memory circuitry, the IOMMU circuitry to translate from the input/output virtual address to the physical address to at least one of read or write to the location in the memory circuitry.

Example 28 includes the apparatus of example 27, wherein the IOMMU circuitry is to free the input/output virtual address when the memory access to the location in the memory circuitry is deallocated.

Example 29 includes the apparatus of example 21, wherein the IOMMU circuitry is to free one or more page tables when the memory access to the location in the memory circuitry is deallocated.

Example 30 includes the apparatus of example 21, wherein the IOMMU circuitry is to increment the counter in response to an asynchronous invalidation call and decrement the counter in response to an acknowledgement of invalidation completion to enable reallocation of the location in the memory circuitry.

Example 31 is at least one non-transitory computer readable storage medium including instructions that, when executed, cause circuitry to at least: increment a counter from a first value to a second value when a memory access to a location in memory circuitry is allocated; decrement the counter from the second value to the first value when the memory access to the location in the memory circuitry is deallocated; and enable reallocation of the location in the memory circuitry when the counter is at the first value.

Example 32 includes the at least one non-transitory computer readable storage medium of example 31, wherein the instructions, when executed, cause the circuitry to flush a buffer when the memory access to the location in the memory circuitry is deallocated.

Example 33 includes the at least one non-transitory computer readable storage medium of example 31, wherein the instructions, when executed, cause the circuitry to: map a physical address in the memory circuitry to an input/output virtual address to provide access to the location in the memory circuitry; and translate from the input/output virtual address to the physical address to at least one of read or write to the location in the memory circuitry.

Example 34 includes the at least one non-transitory computer readable storage medium of example 33, wherein the instructions, when executed, cause the circuitry to free the input/output virtual address when the memory access to the location in the memory circuitry is deallocated.

Example 35 includes the at least one non-transitory computer readable storage medium of example 31, wherein the instructions, when executed, cause the circuitry to free one or more page tables when the memory access to the location in the memory circuitry is deallocated.

Example 36 is a computer-implemented method including: incrementing a counter from a first value to a second value when a memory access to a location in memory circuitry is allocated; decrementing the counter from the second value to the first value when the memory access to the location in the memory circuitry is deallocated; and enabling reallocation of the location in the memory circuitry when the counter is at the first value.

Example 37 includes the method of example 36, further including flushing a buffer when the memory access to the location in the memory circuitry is deallocated.

Example 38 includes the method of example 36, further including: mapping a physical address in the memory circuitry to an input/output virtual address to provide access to the location in the memory circuitry; and translating from the input/output virtual address to the physical address to at least one of read or write to the location in the memory circuitry.

Example 39 includes the method of example 38, further including freeing the input/output virtual address when the memory access to the location in the memory circuitry is deallocated.

Example 40 includes the method of example 36, further including freeing one or more page tables when the memory access to the location in the memory circuitry is deallocated.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
processor circuitry to:
when an input/output virtual address (IOVA) is assigned for a direct memory access (DMA), allocate a buffer and create a reference associated with a page-frame number (PFN);
after the DMA, invalidate the buffer and free the IOVA;
update the reference after the IOVA is freed; and
reallocate the buffer based on a status of the reference.

2. The apparatus of claim 1, wherein the processor circuitry is to create the reference in metadata associated with the PFN.

3. The apparatus of claim 1, wherein the processor circuitry is to invalidate the buffer asynchronously.

4. The apparatus of claim 3, wherein the DMA is a first DMA, and wherein the processor circuitry is to issue a second DMA before the buffer is invalidated.

5. The apparatus of claim 1, wherein the processor circuitry is to invalidate the buffer by flushing the buffer after the DMA is complete.

6. The apparatus of claim 1, wherein the processor circuitry is to map a physical address in memory circuitry to the IOVA to provide access to a location in the memory circuitry, the processor circuitry to translate from the IOVA to the physical address to at least one of read or write to the location in the memory circuitry.

7. The apparatus of claim 1, wherein the processor circuitry is to free one or more page tables when the buffer is invalidated.

8. The apparatus of claim 1, wherein the processor circuitry is to check the reference before reallocating the buffer.

9. The apparatus of claim 8, further including a memory manager to check the reference before reallocating the buffer.

10. At least one non-transitory computer readable storage medium comprising instructions that, when executed, cause circuitry to at least:
when an input/output virtual address (IOVA) is assigned for a direct memory access (DMA), allocate a buffer and create a reference associated with a page-frame number (PFN);
after the DMA, invalidate the buffer and free the IOVA;
update the reference after the IOVA is freed; and
reallocate the buffer based on a status of the reference.

11. The at least one non-transitory computer readable storage medium of claim 10, wherein the instructions, when executed, cause the circuitry to create the reference in metadata associated with the PFN.

12. The at least one non-transitory computer readable storage medium of claim 10, wherein the instructions, when executed, cause the circuitry to invalidate the buffer asynchronously.

13. The at least one non-transitory computer readable storage medium of claim 12, wherein the DMA is a first DMA, and wherein the instructions, when executed, cause the circuitry to issue a second DMA before the buffer is invalidated.

14. The at least one non-transitory computer readable storage medium of claim 10, wherein the instructions, when executed, cause the circuitry to invalidate the buffer by flushing the buffer after the DMA is complete.

15. The at least one non-transitory computer readable storage medium of claim 10, wherein the instructions, when executed, cause the circuitry to map a physical address in a memory to the IOVA to provide access to a location in the memory, the circuitry to translate from the IOVA to the physical address to at least one of read or write to the location in the memory.

16. A computer-implemented method comprising:
when an input/output virtual address (IOVA) is assigned for a direct memory access (DMA), allocating a buffer and creating a reference associated with a page-frame number (PFN);
after the DMA, invalidating the buffer and freeing the IOVA;
updating the reference after the IOVA is freed; and
reallocating the buffer based on a status of the reference.

17. The method of claim 16, wherein creating the reference includes creating the reference in metadata associated with the PFN.

18. The method of claim 16, wherein invaliding the buffer includes invalidating the buffer asynchronously.

19. The method of claim 18, wherein the DMA is a first DMA, and wherein the method includes issuing a second DMA before the buffer is invalidated.

20. The method of claim 16, wherein invalidating the buffer includes invalidating the buffer by flushing the buffer after the DMA is complete.
